(19) United States
(12) Patent Application Publication
(10) Pub. No.: US 2023/0061054 A1
(43) Pub. Date: Mar. 2, 2023

(54) DETERMINING MECHANICAL HEALTH AND ROAD CONDITIONS ENCOUNTERED BY AUTONOMOUS VEHICLES

(71) Applicant: TUSIMPLE, INC., San Diego, CA (US)

(72) Inventors: Ali Reza ABBASPOUR, San Diego, CA (US); Niranjan Shenoy BELLARE, Canton, MI (US); Ali Mohamad HOURY, Dearborn, MI (US); Ravindranath Kallalli HANUMANTHAPPA, Rochester Hills, MI (US)

(21) Appl. No.: 17/820,227

(22) Filed: Aug. 16, 2022

Related U.S. Application Data
(60) Provisional application No. 63/234,192, filed on Aug. 17, 2021.

(51) Int. Cl. G07C 5/08; G05D 1/00

(52) U.S. Cl. CPC G07C 5/0808; G07C 5/0816; G05D 1/0088

(57) ABSTRACT

Disclosed are methods, apparatuses, and computer implemented methods to improve the reliability and safety of the autonomous vehicles. In one aspect, a method for determining an environmental exposure of an autonomous vehicle is disclosed. The method includes obtaining sensor data from one or more shock or vibration sensors mounted to the autonomous vehicle and determining a level of vibrations or a level of shock at the autonomous vehicle based on the obtained sensor data. The method further includes adding the level of vibrations of the autonomous vehicle to an accumulated level of vibrations of the autonomous vehicle and determining whether the accumulated level of vibrations of the autonomous vehicle exceeds a predetermined threshold value for the accumulated level of vibrations of the autonomous vehicle.

### CROSS-REFERENCE TO RELATED APPLICATION

This patent document claims priority to and benefits of U.S. Provisional Patent Application No. 63/234,192 entitled “SYSTEMS AND METHODS FOR MEASURING VIBRATIONS AND HARSH CONDITIONS ENCOUNTERED BY AUTONOMOUS VEHICLES” filed on Aug. 17, 2021. The entire contents of the aforementioned patent application are incorporated by reference as part of the disclosure of this patent document.

### TECHNICAL FIELD

This document relates to autonomous driving systems. In particular, described herein are systems and methods for measuring road conditions and determining autonomous vehicle health.

### BACKGROUND

Self-driving or autonomous vehicles can be autonomously controlled to navigate along a path to a destination. Autonomous driving generally requires sensors and processing systems that perceive the environment surrounding an autonomous vehicle and make decisions based on that perception that ensure safe and reliable operation of the autonomous vehicle. Safe autonomous driving further requires a determination that the autonomous vehicle's mechanical components are operating within acceptable limits. For example, the sensors of the autonomous vehicle can include cameras, light detection and ranging (LiDAR) sensors that use light pulses to measure distances to various objects surrounding the autonomous vehicle, and mechanical sensors.

### SUMMARY

Disclosed in this patent document are methods, apparatuses, and computer implemented methods to improve the reliability and safety of the autonomous vehicles. In one aspect, a method for determining an environmental exposure of an autonomous vehicle is disclosed. The method includes obtaining sensor data from one or more shock or vibration sensors mounted to the autonomous vehicle and determining a level of vibrations or a level of shock at the autonomous vehicle based on the obtained sensor data. The method further includes adding the level of vibrations of the autonomous vehicle to an accumulated level of vibrations of the autonomous vehicle and determining whether the accumulated level of vibrations of the autonomous vehicle exceeds a predetermined threshold value for the accumulated level of vibrations of the autonomous vehicle.

The following features can be included in various combinations. The method can further include comparing the level of vibrations to baseline data from the one or more shock or vibration sensors taken or comparing the level of vibrations to known profiles of vibrations corresponding to properly operating mechanical elements and profiles of vibrations corresponding to failed mechanical elements. The method can further include obtaining temperature data from one or more temperature sensors mounted to the autonomous vehicle and comparing the temperature data to one or more thresholds of baseline temperature data. The method can further include determining, based on the comparing, if the obtained temperature data indicates a mechanical failure or mechanical wear. The method can further include determining, based on the comparing the level of vibrations to baseline data or comparing the level of vibrations to known profiles of vibrations and the comparing the temperature data, whether one or anomalies exists, and based on the determined one or more anomalies rating a severity of the anomalies into a plurality of tiers. The plurality of tiers can include a first tier meaning working within known acceptable parameters, a second tier meaning working near a first warning baseline, a third tier meaning repeatedly exceeding yellow, and a fourth tier meaning immediate attention to the vehicle needed. The method can further include determining that the level of vibrations of the autonomous vehicle exceeds a predetermined vibration threshold. The method can further include performing a maintenance on the autonomous vehicle in response to determining that the accumulated level of vibrations of the autonomous vehicle exceeds the predetermined threshold value for the accumulated level of vibrations of the autonomous vehicle. The adding the level of vibrations of the autonomous vehicle to the accumulated level of vibrations of the autonomous vehicle can be performed in response to determining that the level of vibrations of the autonomous vehicle exceeds the predetermined vibration threshold. The level of vibrations can include an amplitude of the vibrations. The level of vibrations can include duration of the vibrations. The one or more shock or vibration sensors can include multiple shock sensors and multiple vibration sensors. Each of the multiple vibration sensors can be a microelectromechanical system (MEMS) type of sensor. Each of the multiple shock sensors can be a microelectromechanical system (MEMS) type of sensor or a piezoelectric type of sensor. A sensor malfunction is an occurrence of one of: the sensor produces a warning code, the sensor produces an error code, a device in the autonomous vehicle that receives data from the sensor concludes that the data produced by the sensor is of a low quality or has some unexpected or anomalous values, or the device loses its connection with the sensor for a period of time.

In another aspect, an autonomous driving system is disclosed. The system includes a mechanical element monitoring module configured to receive sensor data from one or more shock or vibration sensors mounted to an autonomous vehicle, and a temperature monitoring module configured to receive temperature data from one or more temperature sensors mounted to the autonomous vehicle. The system further includes a harshness measurement module configured to receive road harshness data through the autonomous vehicle via more accelerometers and/or gyroscopes mounted the autonomous vehicle.

The system can include the following features in various combinations. A harshness of road conditions experienced by the autonomous vehicle can be determined from the harshness data based on amplitudes and durations of vibrations, decelerations, and mechanical shocks experienced by the autonomous vehicle. The temperature monitoring module can be further configured to compare the temperature data to one or more thresholds of baseline temperature data, and to determine, based on the comparing, if the received temperature data indicates a mechanical failure or mechanical wear. The mechanical element monitoring module can be further configured to determine a level of vibrations or a level of shock at the autonomous vehicle based on the obtained sensor data, to add the level of vibrations of the autonomous vehicle to an accumulated level of vibrations of the autonomous vehicle, and to determine whether the accumulated level of vibrations of the autonomous vehicle exceeds a predetermined threshold value for the accumulated level of vibrations of the autonomous vehicle.

In another aspect, a method of detecting a loose connection between a sensor in an autonomous vehicle and a processing unit is disclosed. The method registering instances of malfunction of the sensor, and correlating times of occurrence of the sensor malfunctions occurring over a length of time with times of the autonomous vehicle exposure to excessive shock or vibrations over the length of time. the method further includes determining that the connection to the sensor is loose in response to determining that a level or correlation between the times of occurrence of the sensor malfunctions and the times of the autonomous vehicle exposure to excessive shock or vibrations is above a threshold. The times of the autonomous vehicle exposure to excessive shock or vibrations can be determined using one or more accelerometers in the autonomous vehicle.

The following features can be included in various combinations. Each registered instance of malfunction of the sensor includes a time of occurrence of the malfunction. The method further includes sending a message to a control system of the autonomous vehicle indicating that the sensor connection is loose. The method further includes determining that the sensor needs an inspection in response to determining that the level or correlation between the times of occurrence of sensor malfunctions and the times of the autonomous vehicle exposure to excessive vibrations is below a threshold and the number of potential sensor malfunctions registered over the length of time is above a corresponding threshold value. The method further includes sending a message to a control system of the autonomous vehicle indicating that the sensor needs an inspection.

The above and other aspects and features of the disclosed technology are described in greater detail in the drawings, the description and the claims.

### BRIEF DESCRIPTION OF THE DRAWINGS

FIG. 1 illustrates a schematic diagram of a system including an autonomous vehicle according to the disclosed technology.

FIG. 2A shows an example of averaged acceleration data and threshold values for determining the mechanical health of mechanical elements.

FIG. 2B shows an example of impulse acceleration data and threshold values for determining the mechanical health of mechanical elements.

FIGS. 3A-3I shows example mounting locations for shock, vibration, and/or temperature sensors on a truck.

FIG. 4 shows a flowchart of an example method for determining an environmental exposure of an autonomous vehicle according to the disclosed technology.

FIG. 5 shows a flowchart of an example method of detecting a loose connection to a sensor or a need for an inspection of the sensor in an autonomous vehicle according to the disclosed technology.

FIG. 6 illustrates a flowchart of an example method according to the disclosed technology.

### DETAILED DESCRIPTION

Technology disclosed in this patent document can improve the reliability and safety of the autonomous vehicles

Autonomous driving systems (also referred to as autonomous driving vehicles or autonomous vehicles) should safely and reliably accommodate all types of road configurations and conditions. The road conditions can include, for example, conditions of the road surface of a paved or an unpaved road such as, for example, size and number of cracks, potholes or bumps on the road, extent of presence and size of the objects on the road such as small rocks, gravel, sand, debris, etc. The road conditions can also include weather conditions such as rain, snow, wind, dust storms, etc. Vehicle exposure to shocks and vibrations due to road conditions and engine vibration can cause wear to vehicle elements including bearings, bushing, seals, and other mechanical elements. Determining when these mechanical elements are worn and performing any needed maintenance increases safety, reliability, and operational costs. Disclosed are systems and methods for determining road conditions and mechanical element wear.

The autonomous vehicle can use its sensors such as, for example, accelerometers, gyroscopes, vibration sensors, shock sensors, temperature sensors, inertial measurement units (IMUs; an IMU can typically include several accelerometers and gyroscopes), LiDAR sensors, video cameras, RADAR (radio detection and ranging) sensors, and wind speed sensors to determine vehicle conditions and road conditions. Based on the road conditions determined by the autonomous vehicle using data provided by the vehicle sensors, the autonomous vehicle can decide how it can proceed along a planned path. For example, the autonomous vehicle can decide what maximum speed it can maintain on the current stretch of the road (e.g., within the speed limit set for the road), what kind of maneuvers it can safely perform and how fast it can perform those maneuvers. Based on its analysis of the road conditions, the autonomous vehicle can also make corrections to the planned path, if necessary. For example, if the road conditions information determined based on the data collected by the vehicle's sensors indicates that road conditions in the traffic lane of the road in which the vehicle is traveling are worse than the ones in another traffic lane of the road (e.g., the current lane has more potholes in it or more small rocks or debris than another lane), the vehicle can decide to change lanes based on that information. Also, if the road conditions data collected by the vehicle's sensors indicates that the road conditions are too harsh (e.g., vibration measurements exceed a threshold value), such information may be used by the autonomous vehicle to slow down, change lanes or perform another action or maneuver.

One type of autonomous vehicle that the disclosed subject matter can be applied to is a tractor trailer or simi truck that is used worldwide for the transportation of products and materials. Tractor shock and vibration influences an autonomous vehicle system (AVS) (also referred to herein as an autonomous driving system (ADS)) by causing wear of tractor and trailer mechanical elements as well as potentially safety and control problems. Some tractors with integrated AVS will operate in an operational design domain (ODD) that can wear and decay the system mechanical elements that make up the tractor and trailer structures including the drive train, suspension, and other sub-structures. The ODD can include types of roads including highways, freeways, on-ramps, off-ramps, surface streets, road surfaces (e.g., asphalt, concrete, gravel, dirt), temperature range (e.g., −40 C-+55 C), weather conditions (e.g., wind speed, rain, snow, ice, etc.). For example, an ODD may include all or a subset of the foregoing conditions. The wear and decay over time of the mechanical elements can negatively impact the operating conditions of the AVS and can potentially limit where the AVS can be reliably operated.

The wear and decay of the tractor components and systems can cause an increase in the transmission of vibration and shock throughout the tractor and trailer. In addition to operational AVS limits, the foregoing negative effects can reduce the service life in AVS components. For example, a failed suspension spring could cause premature failure of a corresponding shock absorber. Each mechanical element in the vehicle is engineered to operate within a predefined envelope of conditions (e.g., shock and vibration level, temperature, etc.) and operation outside this predefined envelope due to road conditions or failure of related mechanical elements will likely significantly reduce the service life of the affected element. Moreover, vehicle operational safety may be compromised when operating outside these limits.

To help mitigate the negative influence of additional shock and vibration, the physical attributes of the mechanical elements of the tractor and/or trailer can be monitored. By monitoring shock, vibration, and temperature at various locations across the tractor, the AVS can determine if outputs from the various sensors are within normal limits and, if not, the operation of the AVS can be actively adjusted. For example, in response to a determination by the AVS that a suspension related sensor output is out of a normal range, the speed of the tractor can be reduced to reduce stress on the suspension, or a different route avoiding a known rough road in favor of rerouting onto a known smooth road can be performed by the AVS. In another example, if an engine vibration sensor is determined by the AVS to be out of a normal range, the AVS can reduce (or increase) engine RPM or make another engine adjustment to reduce stress on the engine.

An evaluation of the health of the tractor can include evaluation of data from all of the sensors on the tractor. The tractor health and/or the individual sensor outputs can be inputs to a minimal risk condition (MRC) decision process. Preventative maintenance can be performed on the tractor and/or trailer based on individual sensor outputs stored and evaluated over time. Sensor data can be stored and compared to a baseline, or to known sensor profile data and the various meanings of the know profile data. For example, baseline data when a mechanical element is new can be stored and compared to current data as the element wears or ages. When the sensor data is different enough from the baseline data, the AVS may determine that the corresponding mechanical element should be inspected or replaced. In another example, profiles of sensor data corresponding to typical sensor outputs for good mechanical elements, and profiles for the mechanical elements when failing or failed can be stored. Current sensor data can be compared to these profiles and decisions about whether or nor any operation changes need to be made or repair needed. Vibration data can include fast Fourier transforms of time domain data from sensors associated with rotational elements to better understand the health of these components and systems.

According to some example embodiments of the technology disclosed in this patent document, a device or a system in an autonomous vehicle can determine harshness of the road conditions experienced by the autonomous vehicle during a trip. In some example embodiments, the harshness of the road conditions experienced by the autonomous vehicle can be determined based on, e.g., amplitudes and durations of vibrations, harsh decelerations, mechanical shocks etc. experienced by the autonomous vehicle during the trip. This harshness measurements (HM) system can be a part of an ADS/AVS, a part of another system or device in the vehicle or an independent device or system in the autonomous vehicle. The harshness measurements system can include one or more sensors such as accelerometers and/or gyroscopes and one or more processors. In some example embodiments, the one or more processors may be included in the AVS. For example, an accelerometer of the HM system can be of a MEMS (micro-electro-mechanical systems) type or can be a piezoelectric acceleration sensor. The HM system can also include any number of other sensors of any type (e.g., a video camera or a LiDAR for detecting road bumps and potholes that are on the road by that are not encountered by the vehicle and therefore might not be picked up by an accelerometer of the HM device). Sensors of the HM system can be located at the same location in the autonomous vehicle or can be spread among different locations in the autonomous vehicle. For example, if the autonomous vehicle is a tractor-trailer truck, some of the sensors of the HM system can be located at or proximate to the truck while other sensors can be located at or proximate to the trailer.

A report from an HM system that includes information about harsh road conditions that the autonomous vehicle experienced during its trip (e.g., bumps and potholes it drove through, as detected by the HM system) can be used to determine a level of inspection (if any) of the autonomous vehicle needed before its next trip. For example, if the autonomous vehicle was exposed to a lot of potholes etc., it may need an extensive physical inspection because such an exposure could cause misalignment or deterioration of the sensors onboard the vehicle as well as other parts and systems of the vehicle.

Different approaches can be used to obtain safety threshold values for vibrations experienced by different sensors, electrical or mechanical actuators and connectors of the autonomous vehicle as well as for determining their life spans under different vibration levels. One of the methods is a vibration test to find the lifetime and durability of connectors. Finite element simulations (e.g., in a combination with a vibration test) can be used as well. Some of the connectors and sensors have already been tested by their manufacturers and the test data can be available.

The information provided by the HM system of an autonomous vehicle can be used along with the other information such as, for example, distance traveled by the autonomous vehicle, engine temperature history, braking system usage data, alignment/health measurements for perception sensors of the vehicle, etc. to determine and monitor wear and tear condition of the autonomous vehicle.

In addition to the HM system, a mechanical element monitoring system can include microelectromechanical systems (MEMS) vibration sensors, MEMS shock sensors, and/or MEMS temperature sensors. Sensors made using other technologies can also be used such as piezoelectric devices, optical rotation or linear displacement sensors, and other types of temperature sensors. The mechanical element monitoring system can include a dedicated one or more processors or processing can be partially or fully performed at a processor in the AVS. The mechanical element monitoring system can be connected to the AVS. The mechanical element monitoring system may periodically report or provide a handshake with the AVS to confirm connection of the mechanical element monitoring system and reporting a health status (e.g., heartbeat signal) and may include status of one or more mechanical element sensors. For example, a heartbeat signal may be provided from the mechanical element monitoring system to the AVS every second to indicate that the mechanical element monitoring system is active, connected, and in an operational state. The mechanical element monitoring system may include a separate shock/vibration monitoring system (VMS), or the VMS may be included in the mechanical element monitoring system. The handshake may further indicate to the AVS that the vibration monitoring system (VMS) is in an operational state. If the AVS fails to receive the handshake from the mechanical element monitoring system, the AVS determines that an anomaly or error has occurred such as a hardware failure.

The mechanical element monitoring system and the VMS may determine that one or more conditions exist that require a response from the AVS. The determination may be made by comparisons made between sensor data received from the multiple sensors on the tractor/trailer connected to the mechanical element monitoring system and baseline data and/or sensor profiles for each of the different sensors. Depending on which sensor or combination of sensors show anomalous data and how anomalous the data is, different responses are required by the AVS. For example, all the possible anomalies and combinations of anomalies can be categorized and rated in severity into levels. For example, the combinations could be organized into tiers such as good (e.g., green: working within known acceptable parameters); fair (e.g., yellow: working near a first warning baseline); poor (e.g., orange: repeatedly exceeding yellow); critical (red: immediate attention to the vehicle needed). In an example embodiment, responses by the AVS to the tiers can include: green: proceed as normal, no actions to be taken; yellow: proceed as normal, schedule preventative maintenance; orange: take immediate action at next stop; red: stop the vehicle, perform MRC to determine what should be performed next. In some example embodiments, the threshold values for yellow are 2× the threshold values for green, and the threshold values for orange are 2× the threshold values for yellow, and the threshold values for red are 2× the threshold values for orange.

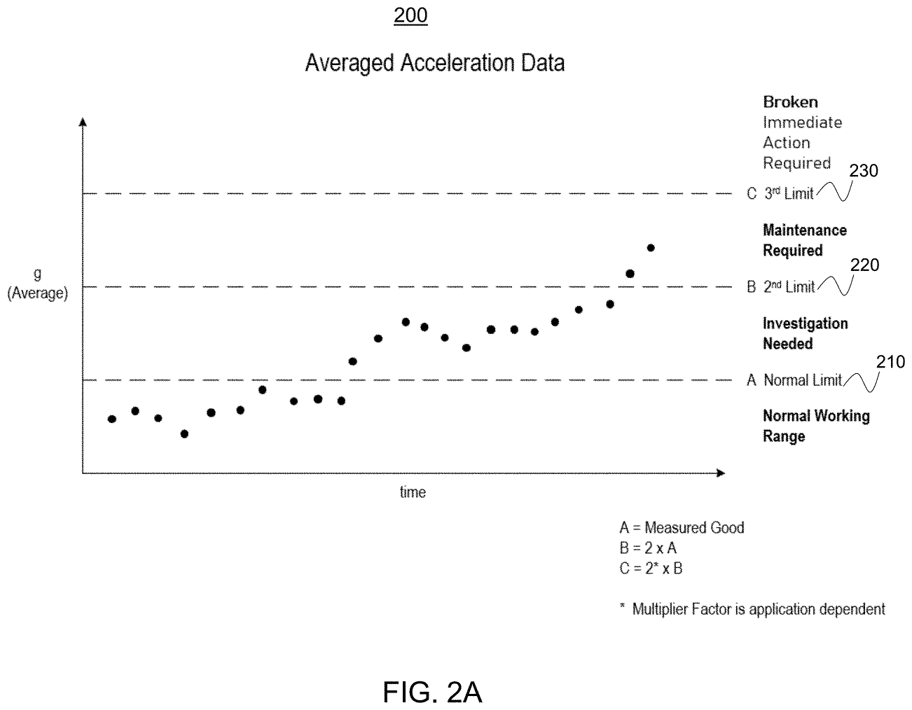

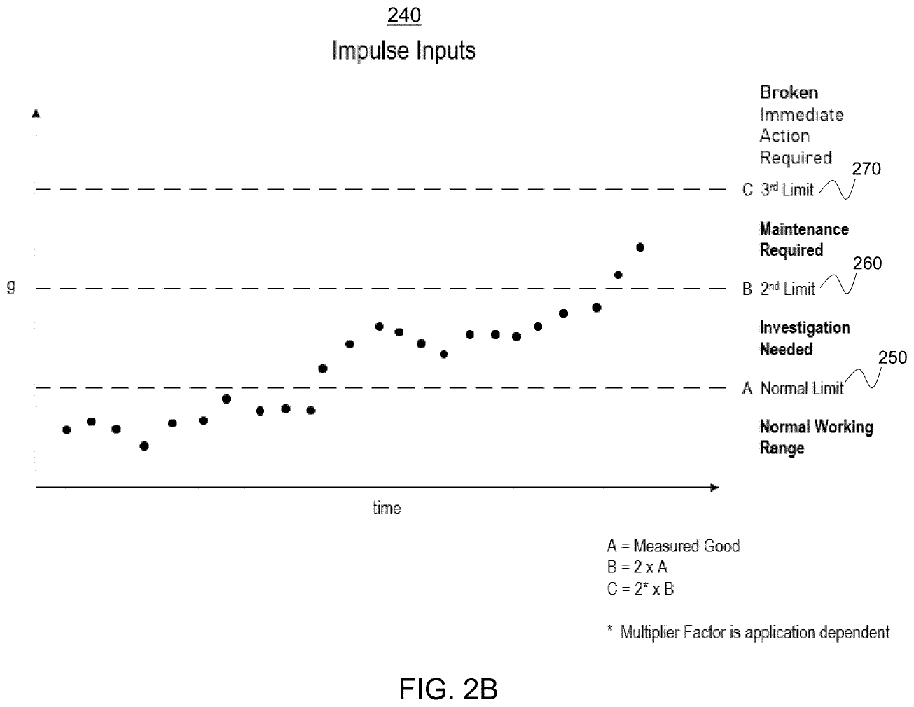

FIG. 2A shows an example plot of averaged acceleration data points taken from an accelerometer over time. For example, impulse acceleration values corresponding to a mechanical element may be averaged over seconds, minutes, hours, or days of use, or may be averaged over a number of trips, or engine stop/start cycles. The plot shows example threshold values for three-tiers of values. The lowest tier is normal limit 210. Acceleration (“g”) values below and up to the normal limit or threshold value 210 correspond to mechanical components that are with normal operating and wear limits. These mechanical elements do not need servicing and appear to be operating normally. A second limit or threshold value 220 corresponds to averaged acceleration values that are above the normal limit 210 and below a higher third limit or threshold 230. Values at or above the normal limit 210 but below the second threshold 220 indicate that some additional investigation of the corresponding mechanical element is warranted. For example, the next time the truck is at a servicing facility a mechanic may be directed to inspect the corresponding mechanical element. The mechanic's inspection may determine that the corresponding mechanical element needs some servicing, repair, or replacement. Values above the second threshold 220 but below the third threshold 230 indicate that the corresponding mechanical element requires maintenance. For example, a mechanical element may need adjustment, lubrication, replacement, or other maintenance. Values above the third threshold 230 indicate that the corresponding mechanical element is broken and immediate action is required to repair the corresponding mechanical element. For example, the truck may need to safely pull off the road and wait for a mobile mechanic to arrive at the truck to repair it, or the truck may be able to continue to the closest repair facility.

FIG. 2B shows a similar plot to FIG. 2A but with impulse acceleration values instead of averaged acceleration values. Impulse acceleration values may be single measurements from an accelerometer. The data points are compared to threshold values as in FIG. 2A to determine if any action should be taken regarding the corresponding mechanical element. Thresholds shown in FIG. 2B include normal limit threshold 250 above which further investigation should occur, second threshold 260 above which maintenance is required, and third threshold 270 above which immediate action to service or replace the corresponding mechanical element is required.

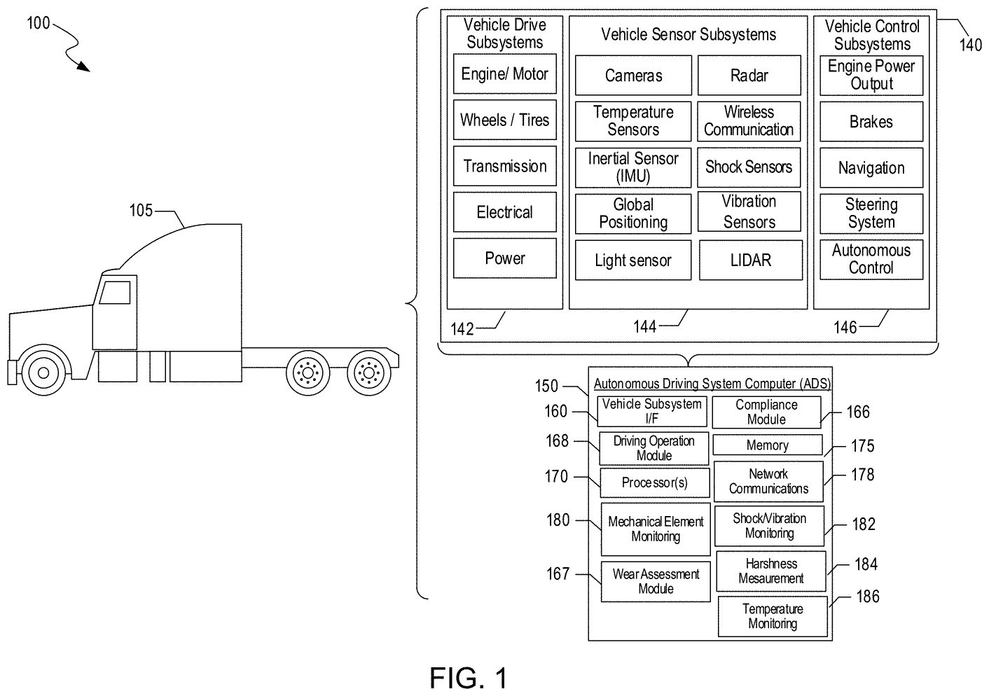

FIG. 1 shows a system 100 that includes a tractor 105 of an autonomous truck. The tractor 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems 146. An engine or motor, wheels and tires, a transmission, an electrical subsystem, and a power subsystem may be included in the vehicle drive subsystems 142. The engine of the autonomous truck may be an internal combustion engine, a fuel-cell powered electric engine, a battery powered electric engine, a hybrid engine, or any other type of engine capable of moving the wheels on which the tractor 105 (also referred to as vehicle 105 or truck 105) moves. The tractor 105 can have multiple motors or actuators to drive the wheels of the vehicle. For example, the vehicle drive subsystems 142 can include two or more electrically driven motors. The transmission of the vehicle 105 may include a continuous variable transmission or a set number of gears that translate the power created by the engine of the vehicle 105 into a force that drives the wheels of the vehicle 105. The vehicle drive subsystems 142 may include an electrical system that monitors and controls the distribution of electrical current to components within the system, including pumps, fans, and actuators. The power subsystem of the vehicle drive subsystems 142 may include components that regulate the power source of the vehicle 105.

Vehicle sensor subsystems 144 can include sensors for general operation of the autonomous truck 105. The sensors for general operation of the autonomous vehicle may include cameras, temperature sensors, an inertial sensor (IMU), a global positioning system, a light sensor, a LIDAR system, a radar system, wireless communications, shock sensors, and vibration sensors.

The vehicle control subsystems 146 may be configured to control operation of the autonomous vehicle, or truck, 105 and its components. Accordingly, the vehicle control subsystems 146 may include various elements such as an engine power output subsystem, a brake unit, a navigation unit, a steering system, and an autonomous control unit. The engine power output may control the operation of the engine, including the torque produced or horsepower provided, as well as provide control of the gear selection of the transmission. The brake unit can include any combination of mechanisms configured to decelerate the autonomous vehicle 105. The brake unit can use friction to slow the wheels in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from a GPS device and one or more predetermined maps so as to determine the driving path for the autonomous vehicle 105. The steering system may represent any combination of mechanisms that may be operable to adjust the heading of the autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR, the cameras, and/or other vehicle subsystems to determine the driving path or trajectory for the autonomous vehicle 105.

An autonomous driving system computer (also referred to herein as an in-vehicle control computer) 150, which may be referred to as a vehicle control unit or VCU, can include, for example, additional hardware and executable instructions to perform autonomous driving activities including any of: a vehicle subsystem interface 160, a driving operation module 168, one or more processors 170, a meta-perception module 165, a memory 175, a wear assessment module 167, a network communications subsystem 178, a mechanical element monitoring system 180, a shock/vibration monitoring system 182, or a harshness measurement (HM) system 184. The VCU 150 controls many, if not all, of the operations of the autonomous truck 105 in response to information from the various vehicle subsystems 140. The one or more processors 170 can be configured to execute the operations associated with the meta-perception module 165 that, for example, allow the system to determine confidence in perception data indicating a hazard, determine a confidence level of a regional map, and to analyze behaviors of agents of interest (also referred as targets) surrounding the autonomous vehicle 105. According to some example implementations of the disclosed technology, an agent of interest or a target can be one of: another vehicle, a vehicle following the autonomous vehicle 105, a vehicle in a vicinity of the autonomous vehicle 105, a pedestrian, a construction zone, or a vehicle proximate to the autonomous vehicle 105. Data from vehicle sensor subsystems 144 may be provided to the meta-perception module 165 so that the course of action may be appropriately determined. Alternatively, or additionally, the meta-perception module 165 may determine the course of action in conjunction with another operational or control module, such as the driving operation module 168 or the wear assessment module 167. Data from the vehicle sensor subsystems 144 may be also provided to the wear assessment module 167. According to some example embodiments, the wear assessment module 167 can be configured to estimate harshness of the conditions encountered by the autonomous vehicle 105 using data provided to it by the vehicle sensor subsystems 144. In certain example embodiments, the wear assessment module 167 can be configured to estimate the harshness of the conditions encountered by the autonomous vehicle 105 using measurements of vibrations in various parts and places of the autonomous vehicle 105 provided to the wear assessment module 167 by one or more sensors of the vehicle sensor subsystems 144. In some example embodiments, the wear assessment module 167 can be configured to determine whether checking or repairing various vehicle systems and components of the autonomous vehicle 105 is required using, e.g., information provided by one or more sensors of the vehicle sensor subsystems 144. In certain example embodiments, the wear assessment module 167 can be configured to estimate wear and tear of the autonomous vehicle 105 using, e.g., data provided by the vehicle sensor subsystems 144. In some example embodiments, various actions (e.g., corrective ones) can be indicated or initiated by the wear assessment module 167 based on, e.g., the data provided to it by one or more subsystems from the vehicle sensor subsystems 144.

The memory 175 may contain additional instructions as well, including instructions to transmit data to, receive data from, interact with, or control one or more of the vehicle drive subsystems 142, the vehicle sensor subsystems 144, or the vehicle control subsystems 146. The in-vehicle control computer (VCU) 150 may control the function of the autonomous vehicle 105 based on inputs received from various vehicle subsystems (e.g., the vehicle drive subsystems 142, the vehicle sensor subsystems 144, and the vehicle control subsystems 146). Additionally, the VCU 150 may send information to the vehicle control subsystems 146 to direct the trajectory, velocity, signaling behaviors, and the like, of the autonomous vehicle 105. The autonomous control vehicle control subsystems 146 may receive a course of action to be taken from one or more modules of the VCU 150 and consequently relay instructions to other subsystems to execute the course of action.

An example aspect of the disclosed technology is related to determining vibration exposure of an autonomous vehicle. In some example embodiments, sensors of the autonomous vehicle, e.g., the ones in the harshness measurements (HM) system of the vehicle, are used to detect accelerations experienced by the vehicle (and/or various parts of the vehicle), e.g., during a trip of the vehicle or over a certain time interval. These accelerations, as detected by the accelerometers of the HM system of the vehicle, for example, are indicative of the levels of vibrations experienced by the autonomous vehicle oved that time interval or trip. Vibration data collected by the vehicle's HM system can be analyzed to determine if any of the detected vibrations exceed a predetermined vibration threshold in their amplitude and/or duration. Furthermore, extent of the vibrations (e.g., number and/or duration of vibration episodes) that exceed the threshold can be integrated or counted for the time interval or the trip and accumulated over an extended period of time (e.g., several weeks or months or years) to monitor the accumulated vibrations exposure value for the vehicle. An accumulated vibrations exposure value exceeding a threshold value (e.g., a threshold value for average age of equipment under harsh vibration conditions) can prompt a request for general maintenance of the vehicle, for example.

Table 1 shows example mechanical elements that wear over time and use. The list in Table 1 is not meant to be exhaustive but includes examples of some of the types of mechanical systems in an autonomous vehicle that can decay with use and which can be monitored by vibration sensors, shock sensors, and/or temperature sensors. Some of the elements that can wear are related to wheels, tires, suspension springs, shocks, steering geometry elements such as tie rod(s), links, pitman arm, drive train such as the engine, transmission, drive shaft(s), differential(s), drive axles, the hood, cab, and the cab plus sleeper.

TABLE 1

| Wear Elements | Example Causes |
|---|---|
| Wheels | Bent or dented wheels will lead to an out of balance condition |
| | that will result in an additional rotational vibration inputs into the |
| | tractor |
| | Out of balance wheels due to lost wheel weights will result in an |
| | additional rotational vibration inputs into the tractor |
| Tires | Uneven treadwear |
| | Tire chunking |
| | Debris embedded in the tire |
| | Flat tire |
| Springs | Overused springs or broken springs |
| | Worn out or broken spring mounts |
| Shocks | Leaking |
| | Broken mounts |
| Steering Geometry | Worn out tie rod ends |
| Elements | Worn out links ends |
| | Worn out pitman arm pivot points |
| Drive Train | Engine - worn out or broken rotational elements |
| | Transmission - worn out gear train; broken gear teeth, worn out |
| | bearings, broken bearings |
| | Drive shaft(s) - bent or lost balancing weight |
| | Differential(s) - worn out gear train; broken gear teeth; |
| | Drive axles - worn out bearings; broken bearing elements; |
| | fractured bearing elements |
| Hood | Worn out forward pivot mounts |
| | Worn out locking/latching hardware |
| Cab | Worn out forward pivot mounts |
| | Worn out airbag(s) |
| | Worn out shock(s) |
| | Decay in the structure allowing for more motion |
| Cab plus Sleeper | Worn out forward pivot mounts |
| | Worn out airbag(s) |
| | Worn out shock(s) |
| | Decay in the structure allowing for more motion |

MEMS temperature sensors (or temperature sensors made using another technology) can be placed on structural elements that are near bearings so that heat generated by the bearings is detected by the temperature sensors. The MEMS vibration sensors can be located on structural materials near areas of interest such as bearings, bushings, or other rotating elements. FFTs can be performed to translate collected time domain data into frequency (spectral) data. The FFTs may assist in determining anomalies. For example, a bearing with 16 elements where one element has failed (e.g., has a flat spot on a spherical bearing surface) may have a spectral component related to the to the rotation rate of the bearing and the single failed bearing element. If multiple bearing elements failed instead of a single element, an additional spectral component may be generated. In this way, the health of the associated mechanical element can be monitored.

Temperature data can be recorded or monitored periodically or intermittently over time. For example, temperature data can be monitored periodically such as one per second or on a different schedule. The temperature can be compared to a baseline or a typical profile of temperature given other operational conditions such as vehicle temperature and current weather conditions. The temperatures taken from the various temperature sensors on the vehicle can be evaluated and classified into a tier such as the green/yellow/orange/red tier descriptions above.

Vibration data from vibration sensors such as MEMs vibration sensors can be recorded or monitored periodically or intermittently over time. Other types of sensors such as various types of accelerometers can be used to measure vibration. The same or similar sensors can also be used to measure shocks or impulse forces exerted on objects attached to chock sensors. Shock and/or vibration data can be averaged or single points can be recorded to show impulse levels. FFTs may be performed on vibration data. Either time domain or frequency domain data (after FFT) can be compared to baseline data or to data profiles to determine which tier described above the vibrations measured by the vibration sensors are within. Shocks can be measured in G's. Shock data can be averaged or individual points recorded. Each of these data sets can be compared to predefined thresholds and subsequent action taken.

In some example embodiments, one or more threshold limits (green to yellow; yellow to orange; orange to red) can be set or adjusted after a tractor service. Some example options for making adjustments to the threshold limits after servicing the tractor include a resetting time and distance counters since the last service. An algorithm in the VMS may adjust one or more thresholds based on services performed on the vehicle, the vehicle age, and anticipated ODD.

Examples of locations for vibration, shock, and/or temperature sensors include wheel hubs, sub frames (engine mount, transmission mount), main frame (′C′ channel rails running longitudinal to the tractor), structural mounting locations (steering gearbox mount; spring mount; shock mount), bearing housings (axle housing; wheel hubs), axle housings, hood mounts, cab/sleeper mount locations (hard pivot mount—hinge point; shock and airbag mounts).

In some scenarios, an increase in transferred vibration throughout the tractor can be attributed to a degradation of mechanical components. When in this operating domain, road debris (furniture, ladders, trash cans, etc.), poor road conditions (potholes, road fractures, bridge seams, etc.) can have a larger impact on safe vehicle operation than when these mechanical components are new. These road conditions can accelerate the decay of the mechanical components. In this way, the road conditions are combined with the mechanical condition of various mechanical components to determine safe operation of the vehicle and in which tier described above the vehicle is operating in.

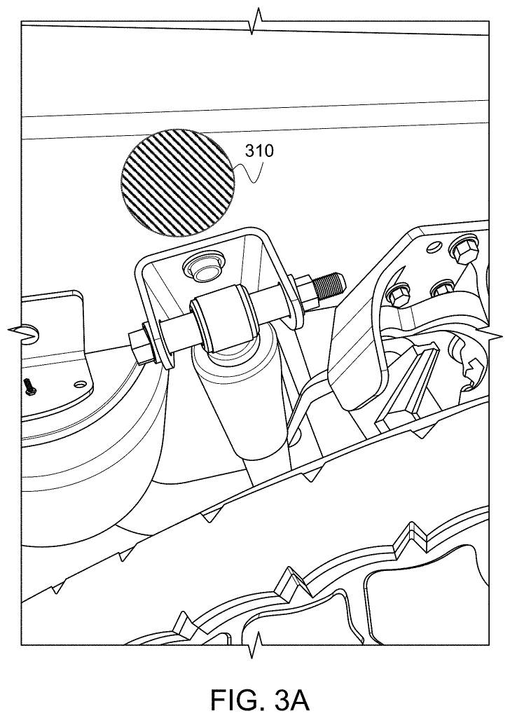

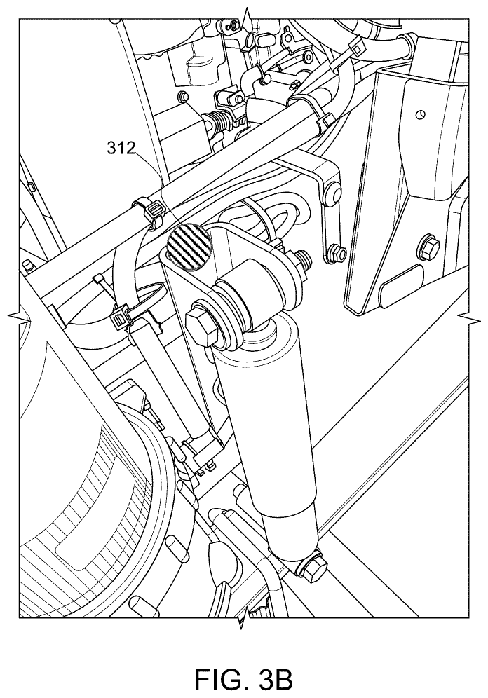

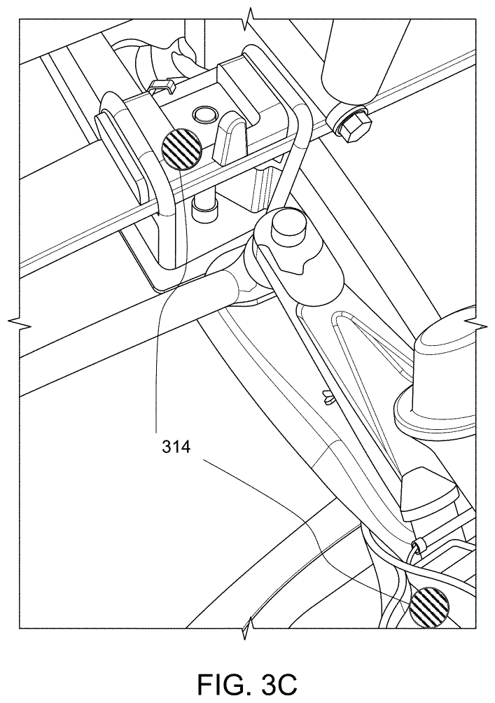

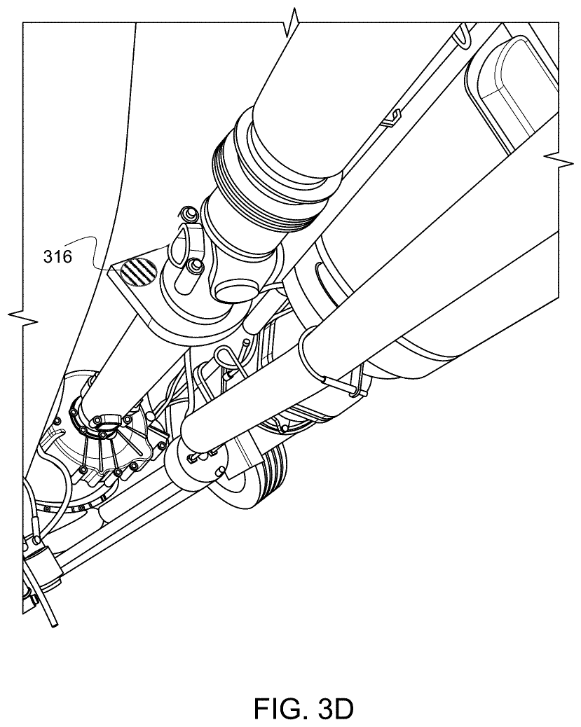

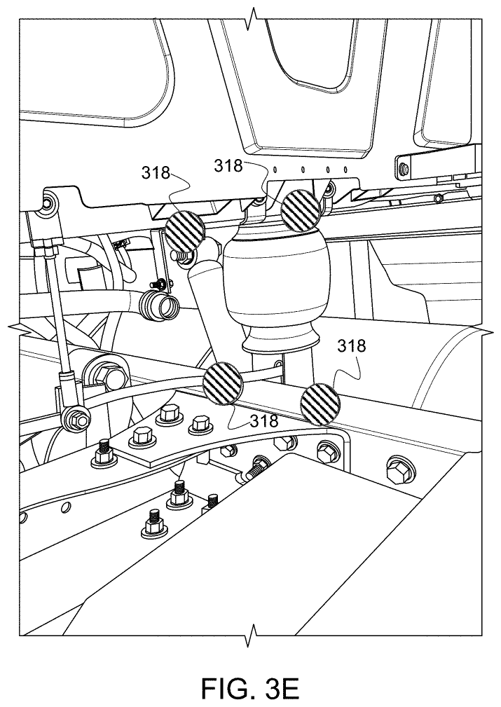

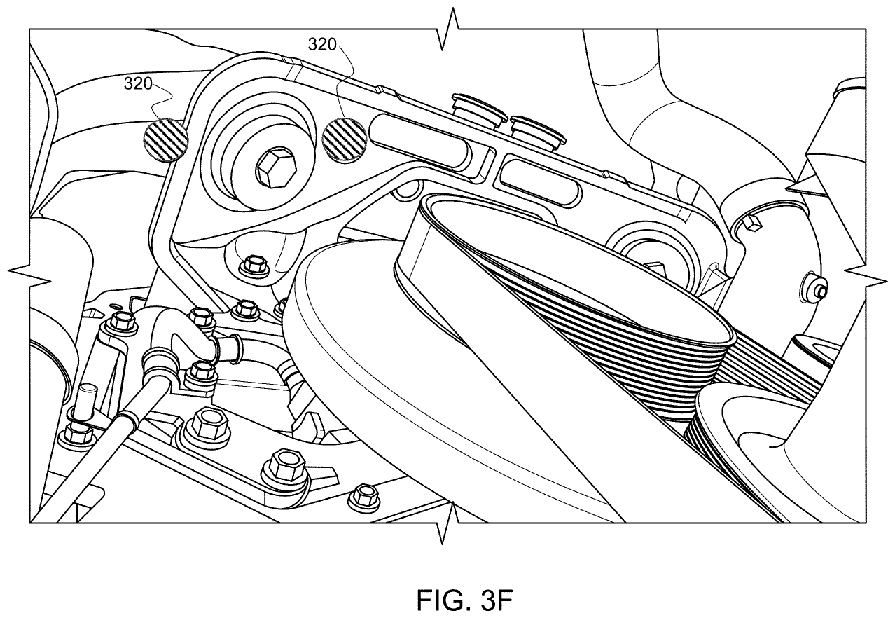

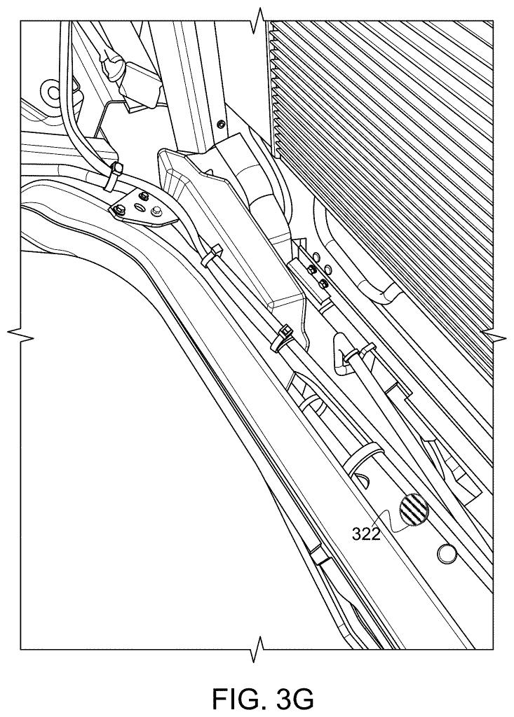

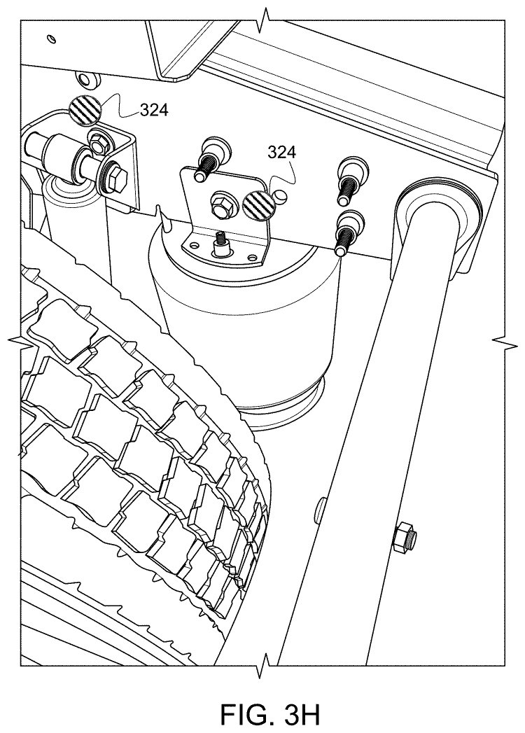

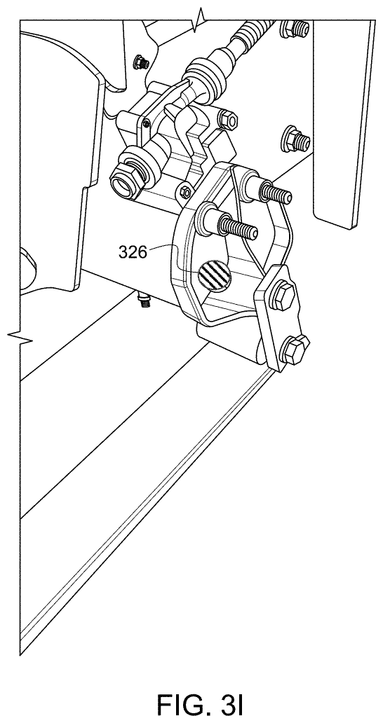

FIGS. 3A-3I shows example mounting locations for shock, vibration, and/or temperature sensors on a truck. The sensors detailed below are mounted in mechanical and/or thermal contact with the mechanical elements of the truck detailed below. Each of the following sensors 310-326 can be a shock sensor, vibration sensor, temperature sensor, or a combination of sensors. FIG. 3A shows a sensor 310 mounted at an upper shock mount. FIG. 3B shows another sensor 312 mounted at a shock mount. FIG. 3C shows sensors 314 mounted at a front axle mount and wheel hub. FIG. 3D shows a sensor 316 mounted at a driveshaft bearing. FIG. 3E shows sensors 318 mounted at upper and lower positions of a sleeper (e.g., a compartment of the cabin of a tractor unit behind the area where a driver sits when driving, often used for sleeping) rear-side shock and airbag. FIG. 3F shows a top-down view of sensors 320 mounted at an engine mount. FIG. 3G shows a sensor 322 mounted at a hood hinge mount. FIG. 3H shows sensors 324 mounted at rear shock and airbag mounts. FIG. 3I shows a sensor 326 mounted at a suspension spring mount.

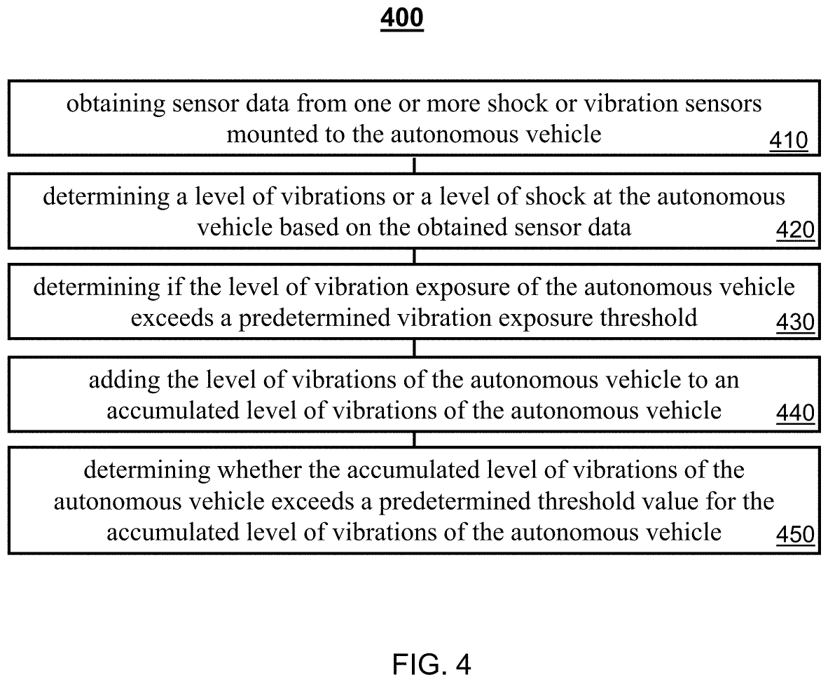

FIG. 4 shows a flowchart of an example method 200 of determining an environmental exposure of an autonomous vehicle according to the disclosed technology. At 410 of the method 400 includes obtaining sensor data from one or more shock or vibration sensors mounted to the autonomous vehicle. At 420 of the method 400 includes determining a level of vibrations or a level of shock at the autonomous vehicle based on the obtained sensor data. In some example embodiments, the level of vibrations can include an amplitude of the vibrations and/or a duration of the vibrations (or can be determined based on the amplitude of the vibrations and/or the duration of the vibrations). At 430 of the method 400 includes determining if the level of vibration exposure of the autonomous vehicle exceeds a predetermined vibration exposure threshold. The step 440 of the method 400 includes adding the level of vibrations of the autonomous vehicle to an accumulated level of vibrations of the autonomous vehicle. The step 450 of the method 400 includes determining whether the accumulated level of vibrations of the autonomous vehicle exceeds a predetermined threshold value for the accumulated level of vibrations of the autonomous vehicle.

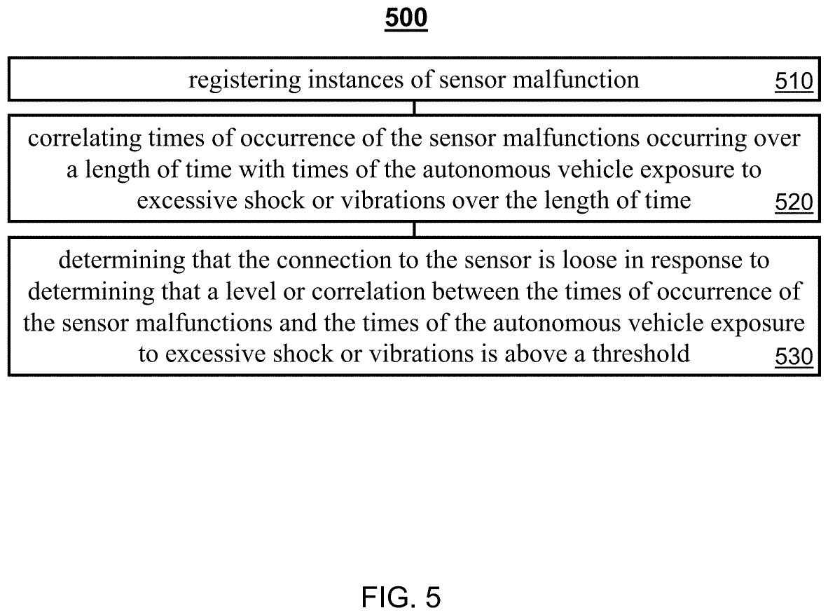

Another example aspect of the disclosed technology is related to a method of detecting a loose connection to a sensor (or a device) and/or a need for an inspection and/or repair of the sensor (or the device) in an autonomous vehicle. FIG. 5 shows a flowchart of an example method 500 of detecting a loose connection to a sensor and/or a need for an inspection and/or repair of the sensor in an autonomous vehicle according to the disclosed technology. The step 510 of the method 500 includes registering (e.g., recording in a database) instances of (potential) sensor malfunction. For example, when the sensor produces a warning or an error code itself or when another device in the autonomous vehicle that receives and/or processes data from the sensor concludes that the data produced by the sensor is of a low quality or has some unexpected or anomalous values, or when that device loses its connection with the sensor for a (brief) period of time, that information, including time of occurrence of such events, can be registered as a potential sensor malfunction. At 520, the method 500 includes comparing (or correlating) times of occurrence of potential sensor malfunctions, occurred over a length of time (e.g., a duration of the vehicle's trip), with the times of the autonomous vehicle exposure to excessive vibrations (e.g., vibrations exceeding a certain amplitude threshold; those vibrations can occur due to potholes or road bumps encountered by the vehicle, for example), as detected, over the length of time, by an HM system of the vehicle including one or more accelerometers. At 530, the method 500 includes determining that the connection to the sensor is loose in response to determining that a level or correlation between the times of occurrence of the sensor malfunctions and the times of the autonomous vehicle exposure to excessive shock or vibrations is above a threshold. The method 500 can also include sending a warning message to a control system of the autonomous vehicle indicating that the sensor connection might be loose. The method 500 can also include determining that the sensor is malfunctioning and/or needs an inspection in response to determining that the level or correlation between the times of occurrence of potential sensor malfunctions and the times of the autonomous vehicle exposure to excessive vibrations is below a threshold and the number of potential sensor malfunctions registered over the length of time is above a corresponding threshold value. The method 500 can also include sending a warning message to a control system of the autonomous vehicle indicating that the sensor is malfunctioning and/or needs an inspection.

The autonomous vehicle (e.g., an autonomous control system of the autonomous vehicle) can analyze the sensor data to determine if any major fault or failure in critical sensors has occurred. The autonomous vehicle can also analyze whether the occurred fault or failure would endanger the safety of the autonomous vehicle during its operation. The autonomous vehicle can decide to either (safely) move out of its travel lane and stop or (safely) stop in the travel lane in response to determining that the occurred fault or failure would endanger the safety of the autonomous vehicle during its operation.

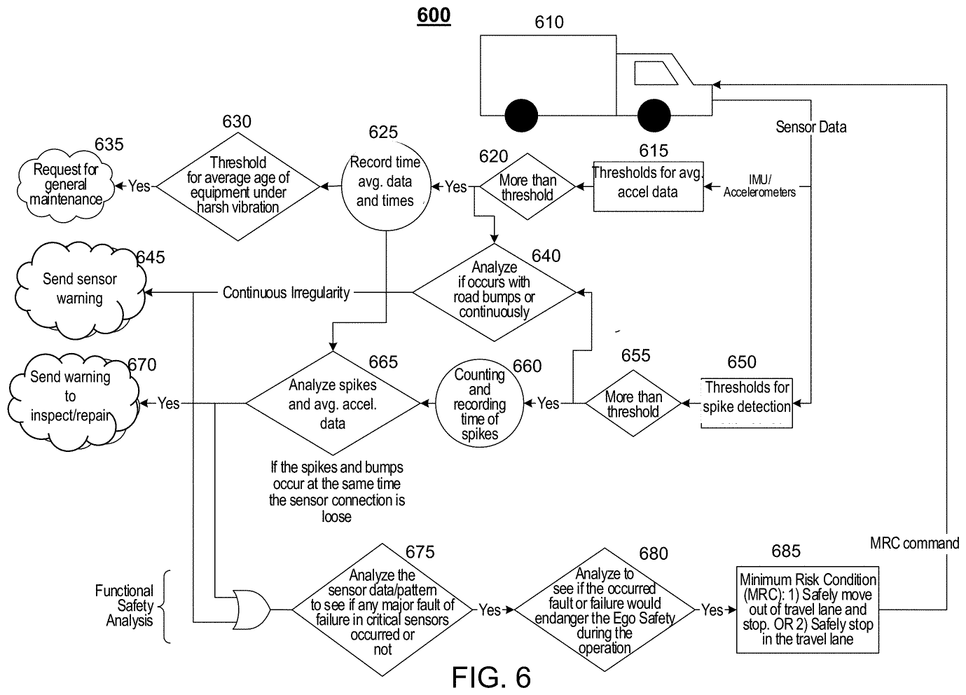

FIG. 6 illustrates a flowchart of an example method for determining the health of the mechanical elements of a truck based on acceleration impulse data and averaged acceleration data according to the disclosed technology. The truck 610 includes various sensors as discussed above such as shock sensors and vibration sensors. Data from these sensors is provided to the ADS which processes the data and issues/sends commands such as MRC commands to other subsystems within the truck.

At 615, thresholding is applied to the sensor average acceleration data as described above with respect to FIG. 2A. At 620, comparison to the thresholds is used to determine which threshold, if any, the average values exceed. The average data and times are recorded at 625. At 630, the data is compared to thresholds or profiles to determine aging or deterioration of performance of mechanical elements that correspond to the sensor data. Data values above a predetermined threshold such as the normal limit thresholds 210 in FIG. 2A or 250 in FIG. 2B, maintenance or inspection will be required/requested at 635.

At 650, thresholding is applied to the sensor impulse (also referred to as spike) data. At 655, comparison to the thresholds is used to determine which threshold, if any, the impulse values exceed. The impulse data and times are recorded at 660. At 665, the impulse and average acceleration data is analyzed to determine if the values exceed a value requiring inspection, repair, or replacement. Data values above a predetermined threshold such as the normal limit thresholds 210 in FIG. 2A or 250 in FIG. 2B, maintenance or inspection will be required/requested at 670.

Average acceleration data and impulse data are analyzed at 640 to determine if a sensor or other component has failed or if a connection is loose. For example, sensor data for a particular sensor that stops or reports unusual or erroneous values when the truck is going over bumps may indicate that the sensor has failed or that a loose connection to the sensor exists. The erroneous or unusual values may be determined, at least in part, by comparing the particular sensor's values to other sensors on the truck.

At 675, the analyzed data and determinations from 640 and 665 are further analyzed to determine if a critical fault or failure has occurred. A critical fault or failure is one that endangers safe operation of the truck or risks serious damage to the trucks mechanical or electrical systems. At 680 the data is analyzed to determine if the fault or failure would endanger the safety of the autonomous vehicle (i.e., ego vehicle, autonomous vehicle (AV), etc. Note that an ego vehicle refers to a vehicle that at least contains the sensors that perceive the environment around the vehicle). At 685, a minimum risk condition can be applied to move the truck out of travel lanes or safely stop the truck in the travel lane.

The method illustrated in FIG. 6 further includes determining a level of vibration exposure of an autonomous vehicle (referred to as road bumpiness measurements in FIG. 6), sensor improper connection detection using the determined level of vibration exposure of the autonomous vehicle, sensor malfunction detection using the determined level of vibration exposure of the autonomous vehicle, and functional safety analysis for the autonomous vehicle that uses the outcomes of the sensor improper connection detection and sensor malfunction detection. “Spike” in can refer to any of: an irregularity in operation of a sensor or a system, an error in operation of the sensor or the system, a spurious data generated by the sensor or the system, a data produced by the sensor or the system that exceeds a certain threshold value, or a data or information that indicates a malfunction related to the sensor or the system (e.g., a loss of communication with the sensor or the system). In some embodiments, an underlying mathematical model may be assumed for sensor data collected from sensors. For example, physical (e.g., electromagnetic or mechanical, etc.) properties of objects (e.g., location of the object, or reflectivity of the object, etc.) in real world typically do not change above a threshold. For example, a truck traveling on a road is not expected to encounter objects that are moving at speeds greater than 200 to 300 miles an hour. Similarly, brightness of an object may not typically change by a factor of 10 in one captured frame time. Any changes to sensor reading beyond such a threshold may be assumed to be “spikes” or spurious readings that have been caused not because the actual reading has changed but because the framework within which the reading is made may have changed (e.g., due to a road bump encountered by the vehicle which caused excessive vehicle vibrations that affected the sensor or due to a sensor malfunction).

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In this disclosure, LiDAR and LIDAR are used to refer to light detection and ranging devices and methods, and alternatively, or additionally, laser detection and ranging devices and methods. The use of these acronyms does not imply limitation of the described devices, systems, or methods to the use of one over the other.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of determining an environmental exposure of an autonomous vehicle, comprising:
obtaining sensor data from one or more shock or vibration sensors mounted to the autonomous vehicle;
determining a level of vibrations or a level of shock at the autonomous vehicle based on the obtained sensor data;
adding the level of vibrations of the autonomous vehicle to an accumulated level of vibrations of the autonomous vehicle; and
determining whether the accumulated level of vibrations of the autonomous vehicle exceeds a predetermined threshold value for the accumulated level of vibrations of the autonomous vehicle.

2. The method of claim 1, further comprising:
comparing the level of vibrations to baseline data from the one or more shock or vibration sensors taken or comparing the level of vibrations to known profiles of vibrations corresponding to properly operating mechanical elements and profiles of vibrations corresponding to failed mechanical elements.

3. The method of claim 2, further comprising:
obtaining temperature data from one or more temperature sensors mounted to the autonomous vehicle; and
comparing the temperature data to one or more thresholds of baseline temperature data;
determining, based on the comparing, if the obtained temperature data indicates a mechanical failure or mechanical wear.

4. The method of claim 3, further comprising:
determining, based on the comparing the level of vibrations to baseline data or comparing the level of vibrations to known profiles of vibrations and the comparing the temperature data, whether one or anomalies exists, and based on the determined one or more anomalies rating a severity of the anomalies into a plurality of tiers.

5. The method of claim 4, wherein the plurality of tiers include a first tier meaning working within known acceptable parameters, a second tier meaning working near a first warning baseline, a third tier meaning repeatedly exceeding yellow, and a fourth tier meaning immediate attention to the vehicle needed.

6. The method of claim 1, further comprising:
determining that the level of vibrations of the autonomous vehicle exceeds a predetermined vibration threshold.

7. The method of claim 1, further comprising:
performing a maintenance on the autonomous vehicle in response to determining that the accumulated level of vibrations of the autonomous vehicle exceeds the predetermined threshold value for the accumulated level of vibrations of the autonomous vehicle.

8. The method of claim 1, wherein the adding the level of vibrations of the autonomous vehicle to the accumulated level of vibrations of the autonomous vehicle is performed in response to determining that the level of vibrations of the autonomous vehicle exceeds the predetermined vibration threshold.

9. The method of claim 1, wherein the level of vibrations includes an amplitude of the vibrations.

10. The method of claim 1, wherein the level of vibrations includes a duration of the vibrations.

11. The method of claim 1, wherein the one or more shock or vibration sensors includes multiple shock sensors and multiple vibration sensors.

12. The method of claim 11, wherein each of the multiple vibration sensors is a microelectromechanical system (MEMS) type of sensor.

13. The method of claim 11, wherein each of the multiple shock sensors is a microelectromechanical system (MEMS) type of sensor or a piezoelectric type of sensor

14. An autonomous driving system, comprising:
a mechanical element monitoring module configured to receive sensor data from one or more shock or vibration sensors mounted to an autonomous vehicle;
a temperature monitoring module configured to receive temperature data from one or more temperature sensors mounted to the autonomous vehicle; and
a harshness measurement module configured to receive road harshness data through the autonomous vehicle via more accelerometers and/or gyroscopes mounted the autonomous vehicle.

15. The autonomous driving system of claim 14, wherein a harshness of road conditions experienced by the autonomous vehicle is determined from the harshness data based on amplitudes and durations of vibrations, decelerations, and mechanical shocks experienced by the autonomous vehicle.

16. The autonomous driving system of claim 14, wherein the temperature monitoring module is further configured to compare the temperature data to one or more thresholds of baseline temperature data, and to determine, based on the comparing, if the received temperature data indicates a mechanical failure or mechanical wear.

17. The autonomous driving system of claim 14, wherein the mechanical element monitoring module is further configured to determine a level of vibrations or a level of shock at the autonomous vehicle based on the obtained sensor data, to add the level of vibrations of the autonomous vehicle to an accumulated level of vibrations of the autonomous vehicle, and to determine whether the accumulated level of vibrations of the autonomous vehicle exceeds a predetermined threshold value for the accumulated level of vibrations of the autonomous vehicle.

18. A method of detecting a loose connection between a sensor in an autonomous vehicle and a processing unit, the method comprising:
registering instances of malfunction of the sensor;
correlating times of occurrence of the sensor malfunctions occurring over a length of time with times of the autonomous vehicle exposure to excessive shock or vibrations over the length of time;
determining that the connection to the sensor is loose in response to determining that a level or correlation between the times of occurrence of the sensor malfunctions and the times of the autonomous vehicle exposure to excessive shock or vibrations is above a threshold.

19. The method of claim 18, wherein the times of the autonomous vehicle exposure to excessive shock or vibrations are determined using one or more accelerometers in the autonomous vehicle.

20. The method of claim 18, wherein a sensor malfunction is an occurrence of one of:
the sensor produces a warning code,
the sensor produces an error code,
a device in the autonomous vehicle that receives data from the sensor concludes that the data produced by the sensor is of a low quality or has some unexpected or anomalous values, or the device loses its connection with the sensor for a period of time.

21. The method of claim 18 wherein each registered instance of malfunction of the sensor includes a time of occurrence of the malfunction.

22. The method of claim 18, further comprising:
sending a message to a control system of the autonomous vehicle indicating that the sensor connection is loose.

23. The method of claim 18, further comprising:
determining that the sensor needs an inspection in response to determining that the level or correlation between the times of occurrence of sensor malfunctions and the times of the autonomous vehicle exposure to excessive vibrations is below a threshold and the number of potential sensor malfunctions registered over the length of time is above a corresponding threshold value.

24. The method of claim 18, further comprising:
sending a message to a control system of the autonomous vehicle indicating that the sensor needs an inspection.
